(19) United States
(12) Patent Application Publication
(10) Pub. No.: US 2026/0217198 A1
(43) Pub. Date: Jul. 30, 2026

(54) VEHICLE ROOF RACK

(71) Applicant: KC IP HOLDINGS, LLC, Flagstaff, AZ (US)

(72) Inventors: Bobby Leang, Los Angeles, CA (US); Adriaan van Niekerk, Phoenix, AZ (US)

(21) Appl. No.: 19/463,229

(22) Filed: Jan. 29, 2026

Related U.S. Application Data
(60) Provisional application No. 63/792,269, filed on Apr. 21, 2025.
(60) Provisional application No. 63/751,155, filed on Jan. 29, 2025.

(51) Int. Cl. B60R 9/04; B60Q 1/00; B60Q 1/24

(52) U.S. Cl. CPC B60R 9/04; B60Q 1/0035; B60Q 1/24

(57) ABSTRACT

A vehicle roof rack includes a rack frame with a pair of first axis frame beams spaced apart from each other, a pair of second axis frame beams spaced apart from each other in a perpendicular relationship to the first axis frame beams, and frame couplings linking respective ones of the first axis frame beams to respective ones of the second axis frame beams. First and second side panels are attachable to a vehicle roof, and each of the side panels include one or more beam platforms to which the rack frame is mounted.

### CROSS-REFERENCE TO RELATED APPLICATIONS

This application relates to and claims the benefit of U.S. Provisional Application No. 63/751,155 filed January 29, 2025 and entitled “VEHICLE ROOF RACK” and U.S. Provisional Application No. 63/792,269 filed on April 21, 2025 entitled “VEHICLE ROOF RACK”, the entire disclosures of which are wholly incorporated by reference herein.

### BACKGROUND

### 1. Technical Field

The present disclosure relates generally to motor vehicle accessories, and more particularly, to vehicle roof racks.

### 2. Related Art

Travelling extended distances over land has been achieved throughout human history in a variety of ways, from simply walking, riding mounted animals, to riding on wheeled vehicles pulled by animals. The widespread availability of motor vehicles has expanded travel opportunities to far-flung locations worldwide, and there are a range of vehicle types or segments that can accommodate each travel style. For instance, the recreational vehicle (RV) segment includes motorhomes, campers, “fifth-wheels,” and “pop-ups.” Such vehicles are intended to support long-term excursions, and thus include bedrooms, kitchens, dining areas, bathrooms, and other living quarters. At a smaller scale, vans may also be configured with such features.

While RVs and vans are suited mostly for highway/on-road travel, “overland” travel over rough terrain and off-road trails require high-clearance trucks and sport utility vehicles with four-wheel drive capabilities. Such vehicles are often smaller than RVs and vans capable of extended self-sustained travel but nevertheless require space for carrying basic living amenities such as food, water, fuel, batteries, shelter, and other camping gear. These trucks and SUVs have limited cargo space in the truck bed or trunk area for all of the critical supplies and equipment necessary for the journey, so external storage beyond that which is available inside the vehicle is typically required.

Roof racks are one possibility for expanding storage options on vehicles. Many recently manufactured vehicles are equipped with side rails that extend on the roof along the length of the vehicle, with those side rails being fixed to reinforced attachment points on the roof. A pair of spaced apart crossbars may be mounted across the side rails, with additional brackets that support cargo boxes, cargo baskets, and the like being attachable to the crossbars. Large, bulky items such as Christmas trees, lumber, and so forth may be secured directly to the crossbars. Alternatively, specialized brackets for securing surfboards, kayaks, skis, and bicycles may be attached to the crossbars. Because the need for such additional storage is not a daily occurrence for many vehicle owners, the crossbars may be removed until needed. Vehicles that are not equipped with side rails may still accommodate crossbars with attachments mounted to tracks, gutters, and other like structures on the roof.

The type and quantity of accessories that can be mounted on a pair of crossbars is limited, so a full roof rack systems may be more suitable for overlanding/off-road vehicles. Such roof racks typically incorporate multiple crossbars that can accommodate attachments of varying lengths and widths and span the entire surface area of the roof. Where it is desirable to maintain access to the sunroof, three-fourths rack or the like that does not interfere with the sunroom may be used. There are generally two types of full roof rack systems: the platform style and the modular style, each having advantages and disadvantages.

The platform style roof rack is typically a unitary structure with a rectangular frame with multiple cross members extending across either or both the lateral and longitudinal frame sections. Feet are mounted to various attachment points on the vehicle roof, with most utilizing those for the factory side rails. Some variations may require the drilling of additional mounting holes in the roof. Rack structure is then mounted onto the feet, thereby securing the structure to the vehicle roof. The rack frame and the cross members may be welded together and constructed of tubular metal. In some variations, a mesh material may underly some portion or the entirety of the rack so that the rack may be utilized as a basket to hold cargo, rather than the cargo or accessory being directly mounted to the rack.

The modular style roof rack likewise employs feet that are mounted to the same attachment points on the vehicle roof. However, there are side panels that are attached to the feet and extend longitudinally along the driver side and passenger side of the roof. Additionally, there are extruded cross members that are typically off-the-shelf T-slot extrusions that define threaded holes at opposing ends and slots along one or more faces of the extrusion. The T-slot extrusions are then bolted to the side panels. In addition to the primary working crossmembers for holding or attaching to cargo, there may be head-end cross members and tail-end cross members that are primarily used for increasing the rigidity of the rack. There may also be a fairing attached to the front end to improve aerodynamics. A wide range of attachments may be mounted to the T-slot extrusions with different brackets and hardware, including rooftop tents, traction boards, cargo boxes, retractable awnings, and so on. The T-slots may also serve as a base for mounting forward-facing light bars, rear-facing chase lights, and other auxiliary lighting.

As a general matter, modular style roof racks and platform roof racks are a compromise between (low profile) appearance and strength. Whereas platform roof racks tend to be stronger and able to carry higher loads, the racks themselves are larger and heavier. Modular style roof racks, on the other hand, have a sleeker appearance with the side panels and the cross members being positioned closer to the vehicle roof. However, the thinner side panels tend to be weaker and the coupling to the T-slot extrusions are prone to damage, particularly when subject to rough driving conditions.

Accordingly, there is a need in the art for an improved roof rack with rack frames that better aesthetically integrate with the vehicle, while having greater strength that allows the carriage of heavy loads and resilience to bumps and shocks of off-road travel that are further amplified with additional cargo weight.

### BRIEF SUMMARY

Embodiments of the present disclosure include a vehicle roof rack, a vehicle roof rack frame structure, and a vehicle roof rack frame coupling. The roof rack is contemplated to be a scalable platform for improved strength and rigidity, enabling greater cargo carriage capacity and resiliency for off-road vehicle installations. Improvements in aesthetic appearance and better integration with vehicle structures are also envisioned.

In one embodiment, a vehicle roof rack may include a rack frame with a pair of first axis frame beams spaced apart from each other, a pair of second axis frame beams spaced apart from each other in a perpendicular relationship to the first axis frame beams, and frame couplings linking respective ones of the first axis frame beams to respective ones of the second axis frame beams. The roof rack may also include first and second side panels that may be attachable to a vehicle roof. Each of the side panels may include one or more beam platforms to which the rack frame is mounted.

According to another embodiment, there may be a vehicle roof rack frame structure. There may be at least one first axis frame beam that defines an upper channel, a lower channel, and one or more outer side channels. Additionally, there may be at least one second axis frame beam that defines an upper channel, a lower channel, and one or more outer side channels. The vehicle roof rack frame structure may further include a frame coupling with a first axis plug and a second axis plug. The first axis plug may be receptively engageable in the lower channel of the first axis beam frame. The second axis plug may be receptively engageable in the lower channel of the second axis beam frame and extend normally to the first axis plug. The frame coupling may define a first axis top slot aligned with the upper channel of the first axis frame beam, as well as one or more first axis side slots aligned with a respective one of the one or more outer side channels of the first axis frame beam. The frame coupling may also include a second axis top slot aligned with the upper channel of the second axis frame beam, and one or more second axis side slots aligned with a respective one of the one or more outer side channels of the second axis frame beam.

Yet another embodiment of the present disclosure may be a vehicle roof rack frame coupling. The coupling may include a coupling body that is defined by a first end face and a second end face perpendicular to the first end face. The coupling body may further be defined by a top face, a first axis end face and a second axis end face perpendicular to the first axis end face. The coupling may further include a first axis plug and a second axis plug extending from a respective one of the first and second end faces of the coupling body. There may also be a first axis alignment slot and a second axis alignment slot on the respective one of the first and second end faces of the coupling body. Each of the alignment slots may be defined by at least a horizontal bottom wall and a vertical side wall. The first axis end face and the second axis end face may each define one or more side access slots. The top face may define at least one top access slot.

The present disclosure will be best understood accompanying by reference to the following detailed description when read in conjunction with the drawings.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a partial front perspective view of a roof rack in accordance with one embodiment of the present disclosure installed on a vehicle;

FIG. 2 is a top perspective view of the roof rack;

FIG. 3 is a top perspective view of the roof rack with a rack frame separated from its side panels;

FIG. 4 is an exploded perspective view of the roof rack with its constituent components of frame beams, frame couplings, crossmembers, and endcaps;

FIG. 5 is a detailed exploded perspective view of a first axis frame beam, and a second axis frame beam attachable to a frame coupling;

FIG. 6 is a cross-sectional view of a frame beam in accordance with one embodiment of the present disclosure taken along axis 6-6 of FIG. 5;

FIG. 7A is an upper perspective view of the frame coupling;

FIG. 7B is a lower perspective view of the frame coupling;

FIG. 8A is perspective view of a frame coupling cover with electrical connections separated from the frame coupling;

FIG. 8B is a perspective view of the frame coupling cover with electrical connections attached to the frame coupling;

FIG. 9 is a detailed perspective view showing an exterior portion of the frame coupling cover;

FIG. 10 is an exploded perspective view of the frame coupling cover and electrical connection posts mounted thereto;

FIG. 11 is an exploded perspective view of a first axis crossmember;

FIG. 12 is a cross-sectional view of the first axis crossmember taken along axis 12-12 of FIG. 11;

FIG. 13A is a front perspective view of an endcap that couples the first axis crossmember to the second axis frame beam;

FIG. 13B is a rear perspective view of the endcap;

FIG. 14 is a cross-sectional view of the endcap taken along axis 14-14 of FIG. 13B;

FIG. 15 is a perspective view of a second axis crossmember; and

FIG. 16 is a cross-sectional view of the second axis crossmember.

### DETAILED DESCRIPTION

The detailed description set forth below in connection with the appended drawings is intended as a description of the several presently contemplated embodiments of a vehicle roof rack and is not intended to represent the only form in which such embodiments may be developed or utilized. The description sets forth the functions and features in connection with the illustrated embodiments. It is to be understood, however, that the same or equivalent functions may be accomplished by different embodiments that are also intended to be encompassed within the scope of the present disclosure. It is further understood that the use of relational terms such as first and second, distal and proximal, lateral, and longitudinal, and the like are used solely to distinguish one from another entity without necessarily requiring or implying any actual such relationship or order between such entities.

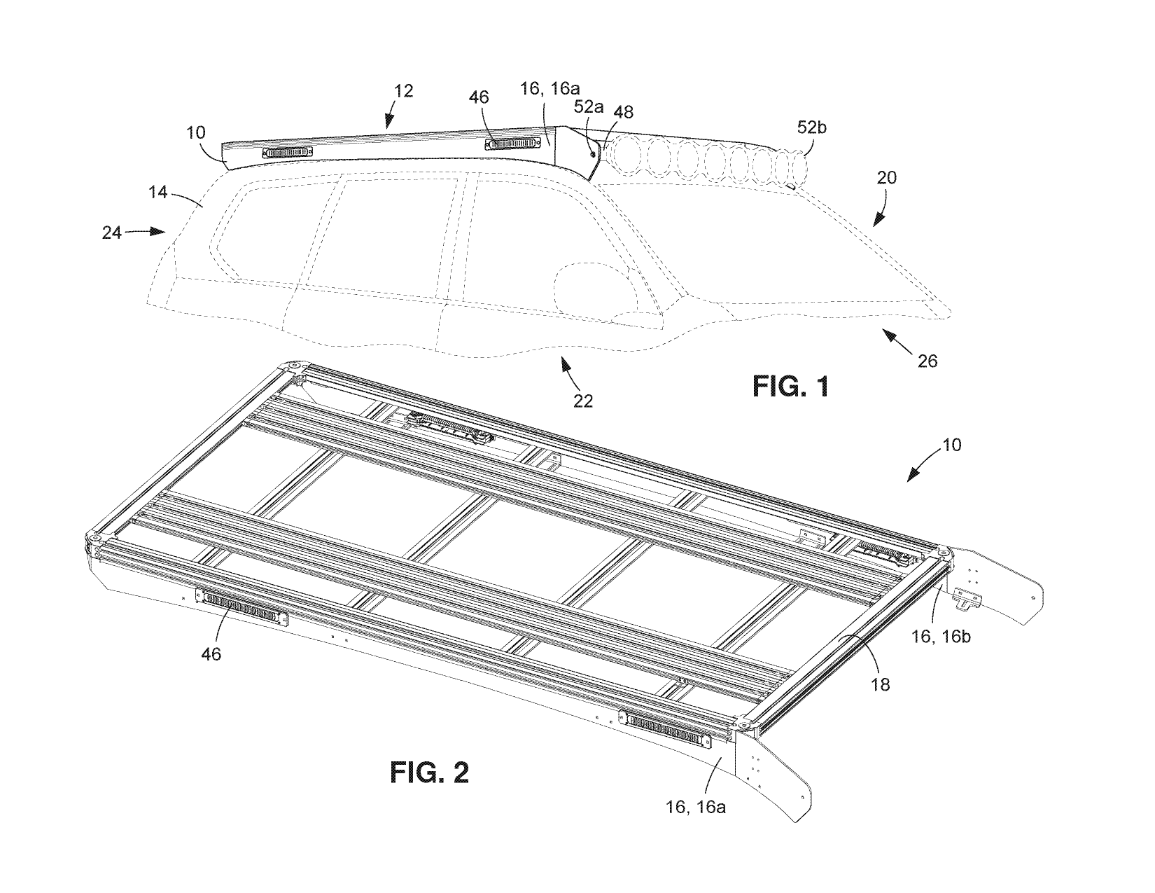

Referring now to FIG. 1, an exemplary embodiment of a roof rack 10 according to the present disclosure is shown installed onto a roof 12 of a vehicle 14. Although the roof rack 10 in the illustrated embodiment is full-sized in that it encompasses the entirety of the roof 12, it will be appreciated that the disclosed features may have alternative sizes e.g., three-fourth sizes, half sizes, and so on. Furthermore, while the roof rack 10 is shown installed on a sports utility type vehicle with a fully enclosed cabin that spans the substantial entirety of its length, it may be adapted to other vehicle types such as pickup trucks, vans, and even sedans.

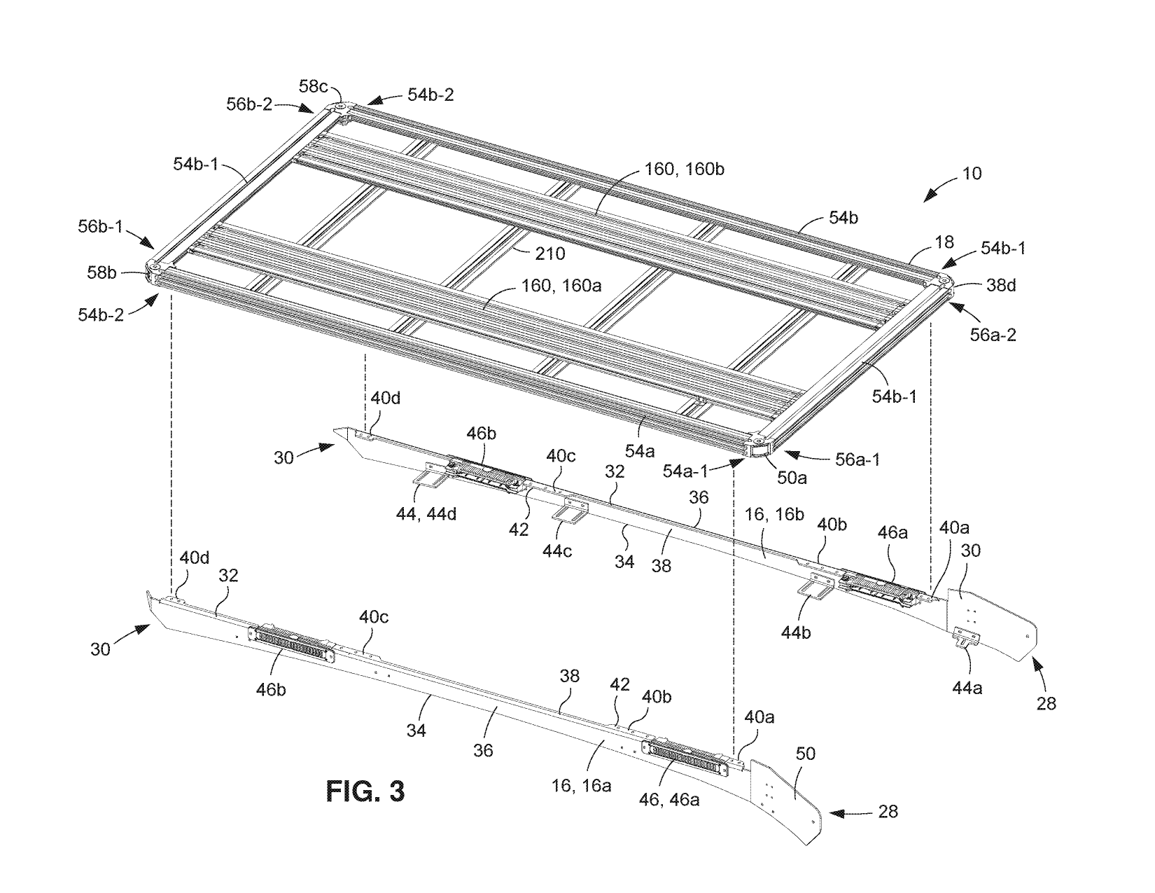

With additional reference to FIGS. 2 and 3, the roof rack 10 is comprised of a pair of side panels 16 and roof rack frame assembly 18. In further detail, there is a passenger side panel 16a, and a driver side panel 16b, which are so referenced because the exemplary vehicle 14 may be a left-hand drive type in which the driver is seated to the left side 20 and the passenger is seated to the right side 22 when viewed from an orientation axis extending from a rear 24 to a front 26. Because there are right-hand drive vehicles where the driver is seated to the right side 22 and the passenger is seated to the left side 20, references to the passenger side and the driver side are arbitrary and for the sake of convenience and consistency only. The specific mounting points for the original equipment rails vary from vehicle to vehicle, so the number and positioning of the foot brackets 44 along the length of the side panel 16 is dependent thereon. The exemplary configuration illustrates the first middle foot bracket 44b being positioned in the vicinity of the first middle platform 40b, the second middle foot bracket 44c being positioned slightly in front of the second middle platform 40c, but this is by way of example only. However, in order to best direct the weight and forces imparted by the roof rack frame assembly 18 to the reinforced mount points on the vehicle 14, the platforms, or at least the two middle platforms 40b, 40c, may be positioned closely to the foot brackets 44.

The side panels 16 are understood to be cut from a sheet of metal material, and have an elongate configuration defined by a front end 28, and opposed rear end 30, a top edge 32, and a bottom edge 34. Furthermore, the side panels 16 have an exterior side 36 and an opposed interior side 38. According to various embodiments, the side panels 16 are form-fitted to the vehicle roof 12, and thus the bottom edge 34 is understood to have a contour that matches that of the vehicle roof 12. The top edge 32, however, accommodates the flat configuration of the roof rack frame assembly 18, so it is understood to be correspondingly flat. In this regard, the side panels 16 define inwardly extending platforms 40 spaced apart across its length, including a front platform 40a, a first middle platform 40b, a second middle platform 40c, and a rear platform 40d. The platforms 40 may be defined by bending extended portions of the sheet metal corresponding thereto. Holes through which various fasteners/bolts may be inserted to secure the roof rack frame assembly 18 to the side panels 16 may also be drilled. While any suitable metal material may be used for the side panels 16, preferably it is rigid aluminum sheet having a thickness of approximately 0.2 inches. This thickness parameter is presented by way of example only, however, and an aluminum sheet of any other desirable thickness to impart a certain balance of rigidity and flexibility may be substituted.

In various embodiments of the present disclosure, the side panels 16 are mounted to the roof 12, and foot brackets 44 serve as the attachment modality. The illustrated example shows four foot brackets, including a front foot bracket 44a, a first middle foot bracket 44b, a second middle foot bracket 44c, and a rear foot bracket 44d. The foot brackets 44 are understood to be separate components that are attached to the side panels 16 with fasteners (e.g., nuts and bolts) rather than being integrally formed therewith, or welded onto the side panels 16, though there may be embodiments where such constructions are used. The foot brackets 44 have a generally L-shaped configuration with a vertical portion interfacing with interior side 38 of the side panel 16, while the horizontal portion interfaces with the mounting points on the roof 12.

Scene lighting may be provided around the perimeter of the vehicle 14, and so scene lighting luminaires 46 may be mounted to the side panels 16. According to the illustrated embodiment, each side may include a front a rear scene lighting luminaire 46a and a rear scene lighting luminaire 46b. The light emission face of the scene lighting luminaires 46 may be substantially flush with the exterior side 36 of the side panel 16, so the side panels 16 may include cutouts to accommodate their housings. Although the scene lighting luminaires 46 are configured as light bars with an array of individual luminaire elements (light source, reflector, lens), other known types of luminaires may be adapted without departing from the scope of the present disclosure.

In addition to scene lighting, the roof rack 10 may be used to mount overhead lights. Such lights are typically configured as a light bar 48 with an array of individual luminaires connected together and provide additional illumination for safe off-road driving in low-light/low visibility conditions. Accordingly, the luminaires are mounted facing a forward direction. The side panels 16 may therefore have a light support extension 50 beyond that segment supporting the roof rack frame assembly 18 and provides a mount point for the light bar 48. A first end 52a is fastened to the light support extension 50 of the passenger side panel 16a, while a second end 52b is fastened to the light support extension 50 of the driver side panel 16b. The top of the roof rack frame assembly 18 may be flush with the top edge of the light support extension 50 to provide a more unitary and streamlined appearance. The light support extension 50 is also understood to serve as wind fairing to deflect airflow around the light bar 48.

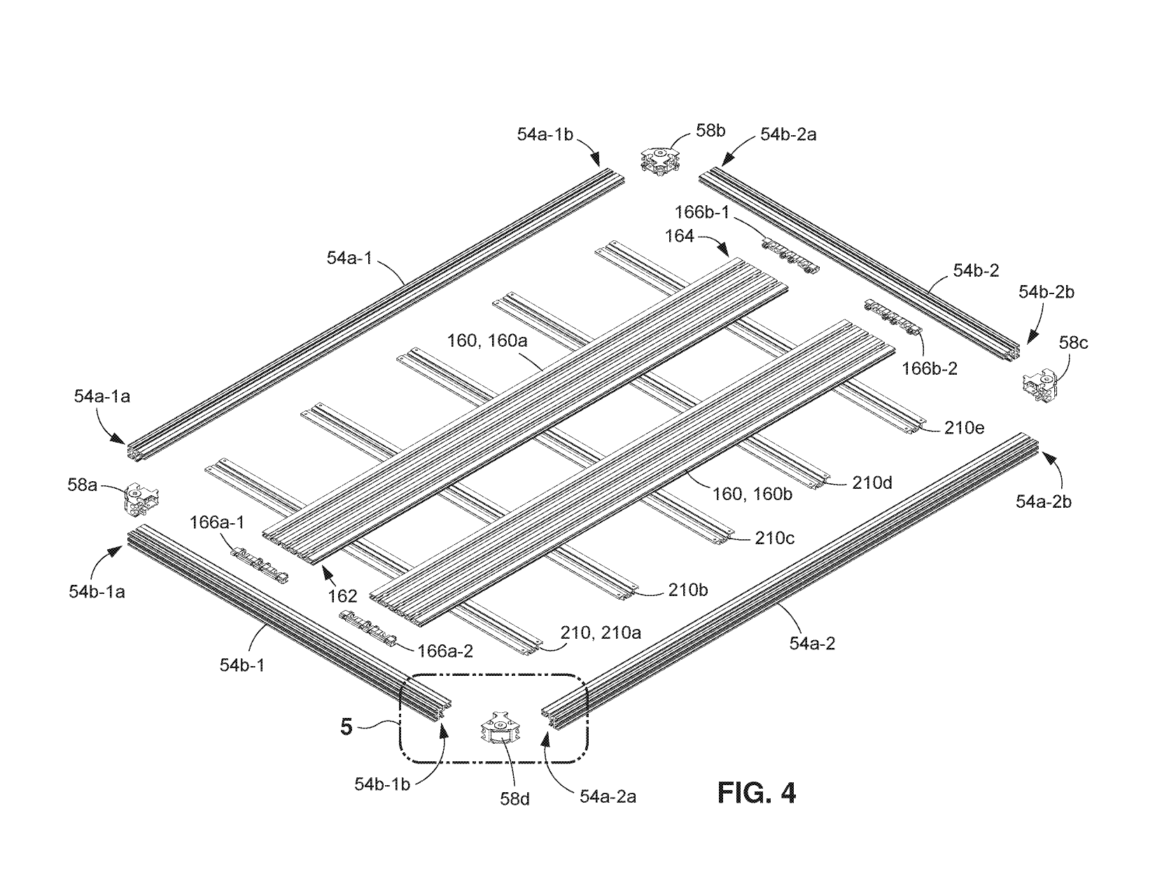

Referring to FIGS. 3 and 4, the roof rack frame assembly 18 has a generally rectangular configuration with a length and a width. The length is defined a pair of elongated first axis frame beams 54a, including a passenger-side first axis frame beam 54a-1 and an opposed driver-side first axis frame beam 54a-2. The width is defined by a pair of second axis frame beams 54b, which includes a front second axis frame beam 54b-1 and an opposed rear second axis frame beam 54b-2. Although the two first axis frame beams 54a-1, 54a-2 are referenced individually, they are understood to be the same and share the same features as will be described in further detail below.

The only distinction is their positioning relative to the other as pertinent to the overall roof rack frame assembly 18. Likewise, the two second axis frame beams 54b-1, 54b-2 are the same, and their positioning with respect to the roof rack frame assembly 18 are their sole distinctions. Along these lines, the first axis frame beams 54a and the second axis frame beams 54b are mostly the same, except for their positioning and orientation. The first axis frame beams 54a are oriented along the longitudinal axis of the rectangular roof rack frame assembly 18, whereas the second axis frame beams 54b are oriented along the lateral axis. Thus, the first axis frame beams 54a are perpendicular to the second axis frame beams 54b. The first axis frame beams 54a may therefore also be referred to as longitudinal frame beams while the second axis frame beams 54b may be referred to as lateral frame beams. Furthermore, the first axis frame beams 54a have a greater length than the second axis frame beams 54b, thus defining the rectangular shape of the overall roof rack frame assembly 18.

The frame beams 54 are connected together with frame couplings 58 to define the roof rack frame assembly 18. Specifically, a first frame coupling 58a positioned at the front passenger side links together the passenger-side first axis frame beam 54a-1 and the front second axis frame beam 54b-1. The passenger-side first axis frame beam 54a-1 is defined by a front end 54a-1a and an opposed rear end 54a-1b, and the front second axis frame beam 54b-1 is defined by a passenger or right end 54b-1a and an opposed driver or left end 54b-1b. The right end 54b-1a of the front second axis frame beam 54b interfaces with the first frame coupling 58a, as does the front end 54a-1a of the passenger-side axis frame beam 54a-1.

A second frame coupling 58b positioned at the rear passenger side links together the passenger-side first axis frame beam 54a-1 and the rear second axis frame beam 54b-2. The rear second axis frame beam 54b-2 is defined by a passenger or right end 54b-2a and an opposed driver or left end 54b-2b. The rear end 54a-1b of the passenger-side first axis frame beam 54a-1 and the right end 54b-2a of the rear second axis frame beam 54b-2 both interface with the second frame coupling 58b.

A third frame coupling 58c positioned at the rear driver side links together the driver-side first axis frame beam 54a-2 and the rear second axis frame beam 54b-2. The driver-side first axis frame beam 54a-2 is defined by a front end 54a-2a and an opposed rear end 54a-2b. The rear end 54a-2b of the driver-side first axis frame beam 54a-2 and the driver or left end 54b-2b of the rear second axis frame beam 54b-2 interface with the third frame coupling 58c.

A fourth frame coupling 58d positioned at the front driver side links together the driver-side first axis frame beam 54a-2 and the front second axis frame beam 54b-1. The front end 54a-2a of the driver-side first axis frame beam 54a-2 and the driver or left end 54b-1b of the front second axis frame beam 54b-1 interface with the fourth frame coupling 58d.

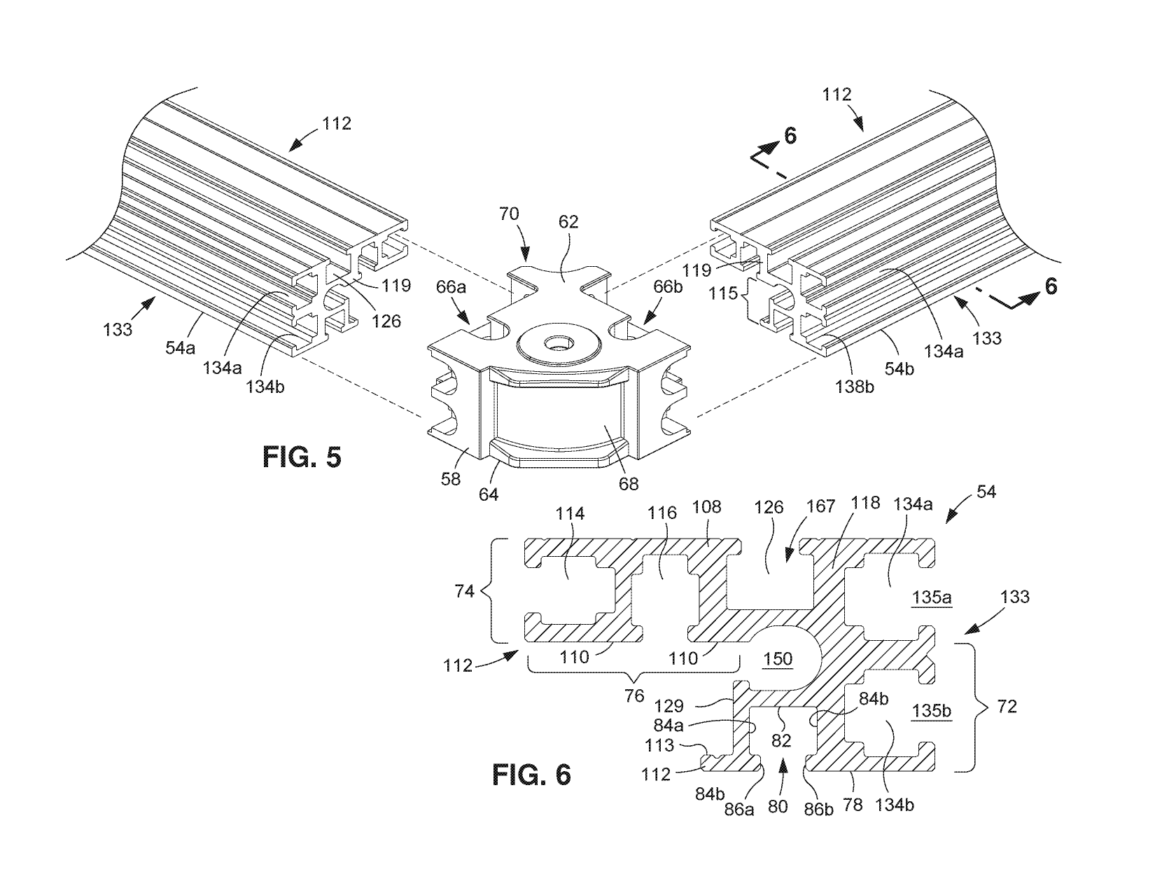

Referring now to FIGS. 5 and 6, additional details of the interconnection of two of the frame beams 54 with the frame coupling 58 will be considered. Although FIG. 5 illustrates only one corner of the roof rack frame assembly 18, it is to be understood that the following features are applicable to the other corners. For the sake of brevity, these details will not be repeated for each of the four corners of the roof rack frame assembly 18. Again, the first axis frame beam 54a and the second axis frame beam 54b are both connected to the frame coupling 58, with the first axis frame beam 54a being perpendicular to the second axis frame beam 54b.

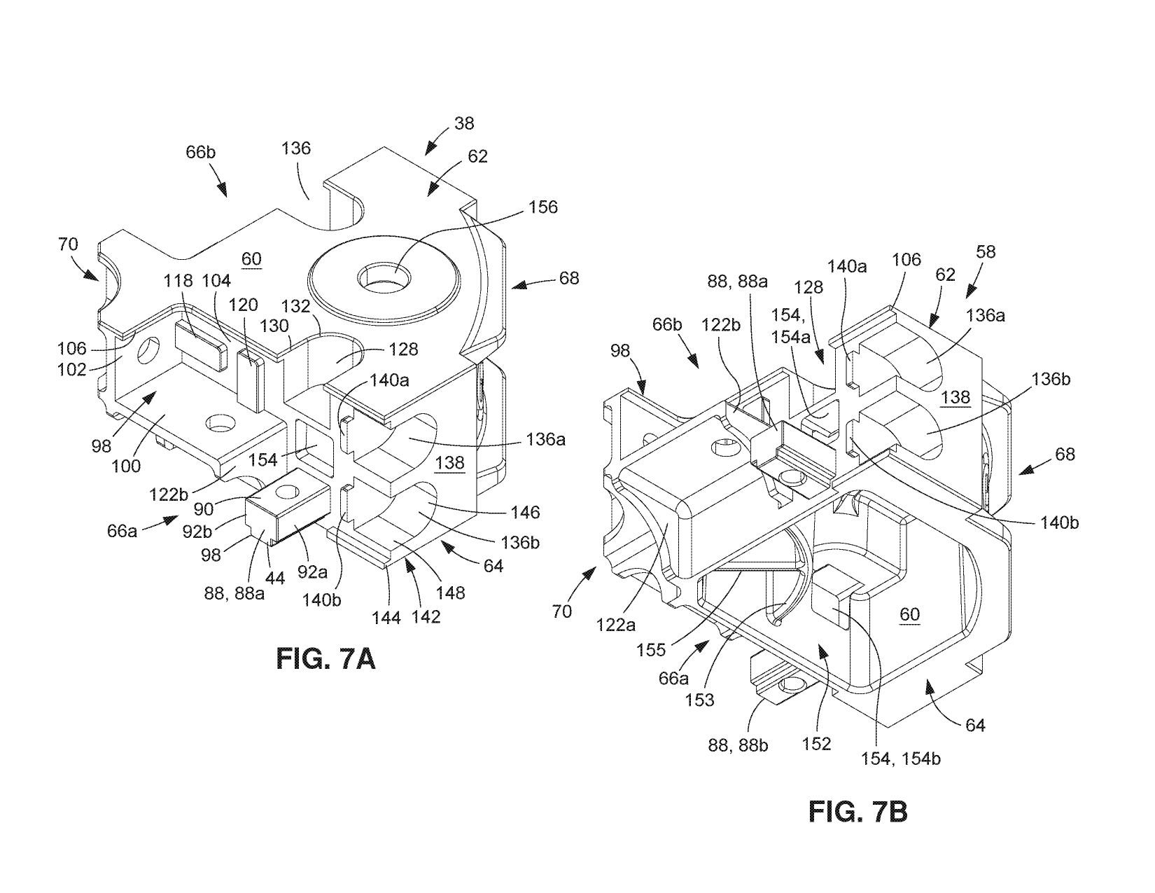

With additional reference to FIGS. 7A and 7B, the frame coupling 58 is defined by a unitary coupling body 60 with a top surface 62, an opposed bottom surface 64, a first axis end face 66a, and a second axis end face 66b. Extending between the first axis end face 66a and the second axis end face 66b is a corner face 68, with the proximal sides of the end faces 66a, 66b defining a center region 70. The first axis end face 66a is perpendicular to the second axis end face 66b. As will be described in further detail below, the first and second axis end faces 66a, 66b are so named because of their role in connecting to or interfacing with the first and second axis frame beams 54.

As best shown in FIG. 6, both the first axis frame beam 54a and the second axis frame beam 54b are understood to have the same cross-sectional profile, and are understood to be extrusions, preferably of aluminum, with specific structural features. Generally, the frame beams 54 are defined by a first elevation base 72 and a second elevation extension 74 with an overhang section 76 that extends over the first elevation base 72. The first elevation base 72 defines a bottom surface 78 of the frame beam 54, and the bottom surface 78 in turn includes an opening to a bottom-facing lower channel 80 that is defined by a top channel surface 82, two side channel surfaces 84a, 84b, and two opposing lips 86a, 86b. With additional reference to FIGS. 7A and 7B, the lower channel 80 is receptive to an alignment plug 88, of which the frame coupling 58 includes a first axis one 88a extending from the first axis end face 66a and a second axis one 88b extending from the second axis end face 66b. The alignment plug 88 is understood to have a similar cross-sectional profile as that of the lower channel 80, in that there is a top surface 90 that abuts the top channel surface 82, a widened section with two sidewalls 92a, 92b that abut the two side channel surfaces 84a, 84b, and a narrowed section 94 that is received within the two opposing lips 86. The alignment plug 88 further includes a bottom surface 96 that is flush or coplanar with the bottom surface 78.

The alignment plug 88 is contemplated to align the frame beams 54 with the frame coupling 58, as well as couple the two structures together. Thus, the alignment plug 88 may be slightly oversized so that it may be frictionally retained inside the lower channel 80.

The frame coupling 58 additionally includes alignment slots 98 on each of the first axis end face 66a and the second axis end face 66b, though in the presented views, the one on the second axis end face 66b is not visible. Because the structure of the alignment slots 98 are the same on both the first axis end face 66a and the second axis end face 66b, based upon the following details of the one for the first axis end face 66a, those having ordinary skill in the art will be able to make an adaptation to the second axis end face 66b. The alignment slot 98 may be defined by at least a horizontal wall 100 and a vertical sidewall 102 and is further bound by the wall of the end face 66a, also referred to as an end face wall 104. A partial periphery of the alignment slot 98 includes a lip extension 106.

Referring back to FIG. 6, the second elevation extension 74 of the frame beam 54 defines a top surface 108 of the overall structure. The overhang section 76 also defines an overhang bottom surface 110, as well as an overhang end 112 with a side opening channel 114. Adjacent to the side opening channel 114 is a bottom opening channel 116. The overhang section 76 is receptively engageable in the alignment slot 98, with there being a frictional fit between the overhang bottom surface 110 and the horizontal wall 100, between the overhang end 112 and the vertical sidewall 102, and between the lip extension 106 and the top surface 108. To further aid alignment, a first alignment tab 118 engages with the side opening channel 114 and a second alignment tab 120 engages with the bottom opening channel 116 before fully seating the frame beam 54 into the frame coupling 58 such that and end face 119 of the frame beam 54 abuts against the end face wall 104.

The horizontal wall 100 extends from both the vertical sidewall 102 as well as the end face wall 104, but for further reinforcement, there may be vertical gussets 122, including a first vertical gusset 122a that is aligned with the vertical sidewall 102, and a second vertical gusset 122b that coincides with the end of the horizontal wall 100. The second vertical gusset 122b is further contemplated to be an alignment modality for the first elevation base 72, and specifically an inward wall 124 thereof.

The various embodiments of the present disclosure contemplate the mounting of accessories to the frame beams 54, so multiple T-slot channels with different opening orientations are provided. One implementation contemplates that the various T-slot channels described herein are sized to accommodate M8 size hardware, though the modification of the dimensional parameters to accommodate other hardware sizes is deemed to be within the purview of those having ordinary skill in the art.

Defined on the top of the frame beam 54 is an upper channel 126 with a top-facing opening. In contrast to the other channels described above with ends that are contemplated to be closed off by the frame coupling 58, the upper channel 126 is intended to be open from both ends to allow for the insertion of T-slot hardware that otherwise could not be inserted through the narrowed lip portions of the channel. Accordingly, the end face 66 of the frame coupling 58 defines a top access slot 128 that is aligned with the upper channel 126 of the frame beam 54. The top access slot 128 has a width greater than a narrowed opening 127, but about the same as the principal portion of the upper channel 126. Preferably, though optionally, the top access slot 128 is defined by a short straight portion 130 and a half-moon portion 132. The T-slot hardware may be inserted through the top access slot 128 and slid into the upper channel 126 of the frame beam 54.

Additionally defined on the outer sides 133 of the frame beam 54, are two side channels 134, including an upper side channel 134a and a lower side channel 134b both with side-facing openings. The upper side channel 134a is part of the second elevation extension 74, while the lower side channel 134b is part of the first elevation base 72. The side channels 134 each define a corresponding narrowed opening 135 because of the inward lips, including a first narrowed side opening 135a for the upper side channel 134a and a second narrowed side opening 135b for the lower side channel 134b. Similar to the upper channel 126, the side channels 134 are contemplated to be open from both ends to allow for the insertion of T-slot hardware. Thus, the end face 66 of the frame coupling 58 defines corresponding side access slots 136 each aligned with the side channels 134 of the frame beam 54. In further detail, there is a first side access slot 136a with an opening to a side face 138 of the coupling body 60, as well as to the end face 66. Further locating tab 140a, 140b may extend from the end face 66a positionally corresponding to the upper and lower side channels 134a, 134b, respectively. Such locating tabs 140 may be frictionally retained within the confines of the side channels 134 of the frame beam 54. The overall body of the frame beam 54 are understood to be captured by the frame coupling 58, so the lip extension 106 may continue to those positions of the frame coupling toward the side face 138 and abut against the top surface 108. Along these lines, the bottom end of the coupling body 60 may also include a stepped lip 144 that abuts against the bottom surface 78 of the frame beam 54. Preferably, though optionally, the side access slots 136 are each defined by a short straight portion 146 and a half-moon portion 148, such that the T-slot hardware may be inserted through the side access slot 136 and slid into the side channel 134 of the frame beam 54. The side access slots 136 therefore have a width greater than the narrowed openings 135, but about the same as the principal portion of the side channel 134.

In addition to mounting accessories with T-slot hardware, the various channels of the frame beams 54 may be utilized to route wiring connected to various electrical accessories, such as the aforementioned scene lighting luminaires 46 or the light bar 48. Although the upper channel 126 or the side channels 134 may be utilized, various embodiments of the present disclosure contemplate a central wire routing channel 150. So that wiring can be routed from one frame beam 54 to another, the coupling body 60 may have a hollow interior 152. The central wire routing channel 150 is also contiguous with wire routing opening 154 that is defined on the respective end faces 66. That is, the first axis end face 66a defines a first wire routing opening 154a into the hollow interior, while the second axis end face 66b defines a second wire routing opening 154b into the hollow interior. In some cases, there may be a need to route the wire out of the frame coupling 58, so the coupling body 60 may define a top wire routing opening 156.

The coupling body 60 may be structurally reinforced inside the hollow interior 152. Accordingly, there may be a circular gusset 153 along with a radial crossmember 155 extending from the center region 70 to the circular gusset 153. This interior reinforcement of the coupling body 60 is presented by way of example only, and other reinforcement structures may be incorporated into the hollow interior 152.

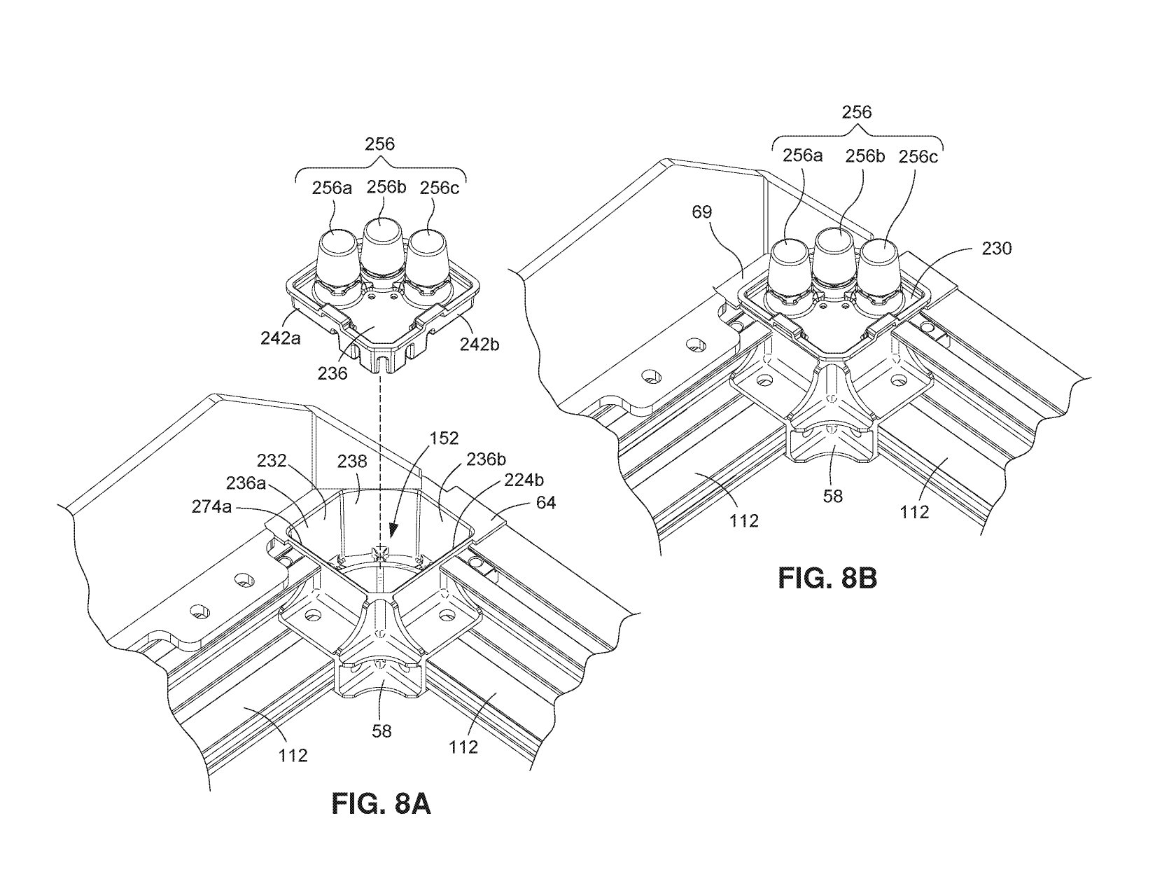

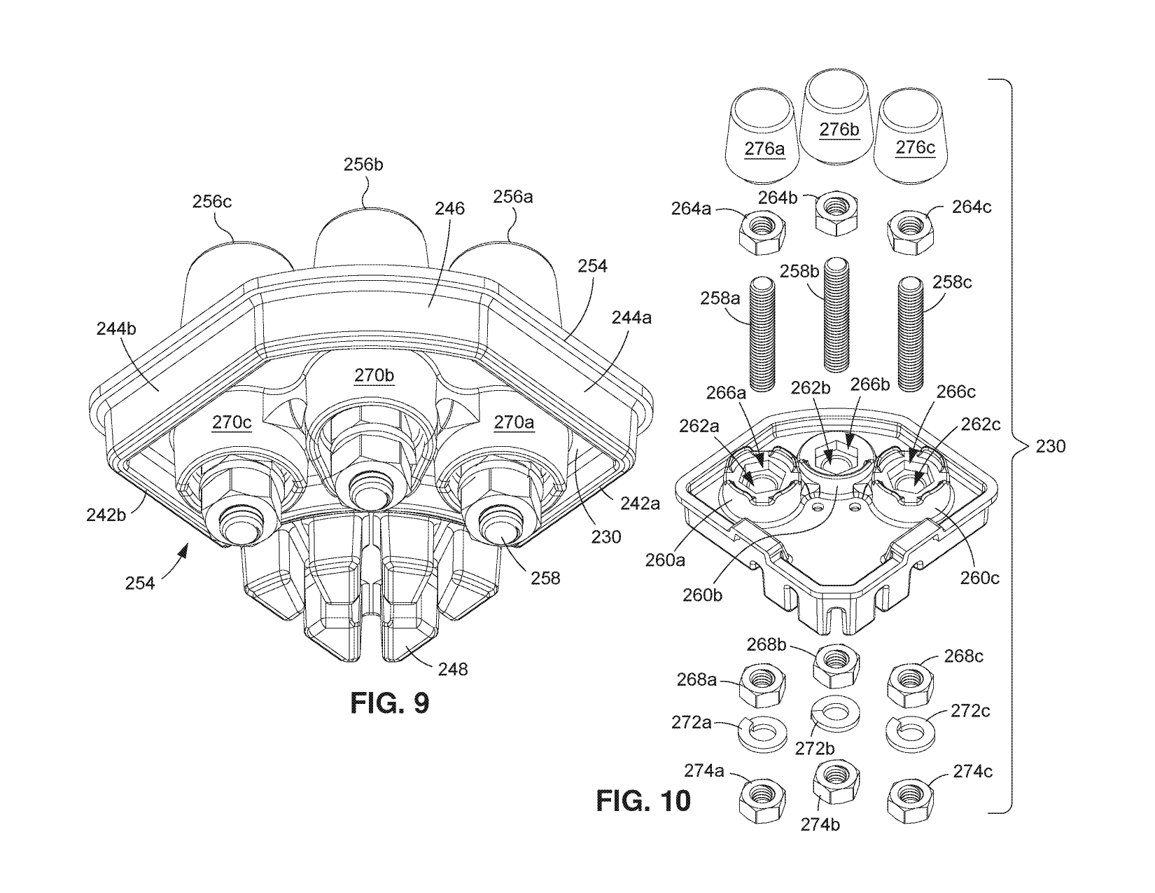

In addition to the top wire routing opening 156 that provides access to the hollow interior 152 of the coupling body 60 and to the wire routing openings 154, additional modalities for electrical interconnections may be provided via the opposite side, from the bottom surface 64. With further reference to FIGS. 8A, 8B, and 9, a coupling cover 230 may be fitted onto the frame coupling 58. The coupling cover 230 is understood to have a frictional fit to the coupling body 60. In further detail, the coupling body 60 also defines an interior perimeter 232 with a first end face segment 234a and a second end face segment 234b generally perpendicular thereto. Additionally, the interior perimeter 232 has a first outer face segment 236a and a second outer face segment 236b perpendicular thereto. Lastly, the interior perimeter 232 has an arcuate connecting segment 238 between the outer face segments 236.

The coupling cover 230 is understood to have a rim profile 240 that corresponds to the interior perimeter 232 of the coupling body 60. Thus, the rim profile 240 may be defined by a first end face segment 242a and a second end face segment 242b, a first outer face segment 244a and a second outer face segment 244b, and an arcuate connecting segment 246. When the coupling cover 230 is attached, the first end face segment 242a of the rim profile 240 faces and abuts against the first end face segment 234a of the interior perimeter 232. Along these lines, the second end face segment 242b of the rim profile 240 faces and abuts against the second end face segment 234 of the interior perimeter 232, the first outer face segment 244a faces and abuts against the first outer face segment 236a, the second outer face segment 244b faces and abuts against the second outer face segment 236b, and the arcuate connecting segment 246 faces and abuts against the arcuate connecting segment 238. A portion of the end face segments 242, the entirety of the outer face segments 244, and the entirety of the arcuate connecting segment 246 define a contiguous wall structure with minimal flex. A corner between the end face segments 242, however, includes multiple retention fingers 248 that provides additional flexibility to frictionally engage against both the end face segments 234, as well as the circular gusset 153 and the radial truss 155 in the coupling body 60. The rim of the coupling cover 230 also defines a perimeter flange 250 that abuts against the bottom surface 64 of the coupling body 60 and serves as a limit to the insertion depth into the same.

The coupling cover 230 is further defined by an exterior face 252 and an interior face 254, with electrical connectors 256a-256c extending between for access from each side. In the illustrated example, and as shown in additional detail in FIG. 10, the electrical connectors 256 are a binding post type with a threaded conductive post 258. According to an exemplary embodiment, there are three electrical connectors 256a, 256b, and 256c, though this is not by limitation. Other embodiments may include just one, two, or more than three. Additional details of the electrical connectors 256 including its constituent components will be described below.

The exterior face 252 of the coupling cover 230 defines a first exterior boss 260a, a second exterior boss 260b, and a third exterior boss 260c, each with corresponding openings 262a- 262c. The threaded conductive posts 258 are understood to be inserted through the corresponding openings 262 and secured in position with exterior nuts 264 that are fitted within exterior nut cavities 266 defined within the respective exterior bosses 260. The threaded conductive posts 258 may be secured from the interior side with a set of corresponding first interior nuts 268 fitted within respective interior bosses 270a-270c defined on the interior face 254 of the coupling cover 230. Lock washers 272 may be inserted onto the interior side of the respective threaded conductive posts 258 with second interior nuts 274 locking the lock washers 272 into place. In between the one lock washer 272 and the second interior nut 274, a ring terminal to an electrical conduit/wire may be inserted. A galvanic connection may thus be established between such an electrical conduit via the ring terminal, to the interior nut 274 and the lock washer 272, and to the threaded conductive post 258. An additional electrical connection may be made from the exterior of the coupling cover 230 via another ring terminal terminating an electrical conduit that is inserted onto the threaded conductive post 258. A retention cap 276 may be threaded onto the threaded conductive post 258, forming a mechanical and electrical connection between the ring terminal and the exterior nut 264, as well as to the threaded conductive post 258. Thus, the threaded conductive post 258 serves as an electrical connection bridge for a conduit extending from the exterior of the coupling cover 230 and a conduit extending from the interior of the coupling body 60.

Although specifics of the binding post type electrical connectors 256 have been described, this is by way of example only and not of limitation. Alternative embodiments of the present disclosure may substitute other connector types without departing from the scope of the present disclosure. The embodiments of the frame couplings 68 implementing the electrical connections by way of the removable coupling cover 230 contemplate the routing of electrical conduits on an as-needed basis. In other words, the installer or end user of the roof rack 10 selectively add electrical accessories, with the wiring therefor being added at the time of assembly/installation. The wiring may be routed through the frame beams 54 and into the interior of the coupling body, and with the coupling cover 230 removed, connected to the electrical connectors 256. The coupling cover 230 is then attached to the coupling body 60, and the exterior conduits may then connected to the electrical connectors 256. In other embodiments, rather than a removable cover, the electrical connectors 256 may be permanently fixed to the frame couplings 58, with the routing of the connections from the interior of the coupling body 60 being made to an different interconnect that is accessible from the exterior at an alternative location such as the wire routing opening 154.

Referring back to FIGS. 3 and 4, the roof rack frame assembly 18 also includes one or more first axis crossmembers 160 that extend along the longitudinal axis. Specifically, there may be a right or passenger side first axis crossmember 160a and a left or driver side first axis crossmember 160b, both of which extend from the front second axis frame beam 54b-1 to the rear second axis frame beam 54b-2 and define a front end 162 proximal to the front second axis frame beam 54b-1 and an opposed rear end 164 proximal to the rear second axis frame beam 54b-2. As further detailed in FIG. 11, endcaps 166a, 166b are attached to each of the front ends 162 and the rear ends 164 of the first axis crossmembers 160. Specifically, there is a first front endcap 166a-1 attached to the front end of the right side first axis crossmember 160a, and a first rear endcap 166b-1 attached to the rear end of the same. There is also a second front endcap 166a-2 attached to the front end of the left side first axis crossmember 160b, and a second rear endcap 166b-2 attached to its rear end. Although two first axis crossmembers 160 are depicted as part of the roof rack frame assembly 18, this is by way of example only and not of limitation. Additional first axis crossmembers 160 may be part of the roof rack frame assembly 18, or there may be just one first axis crossmember 160. According to various embodiments of the present disclosure, the first axis crossmembers 160 are extruded metal, preferably aluminum, though any other material may be substituted.

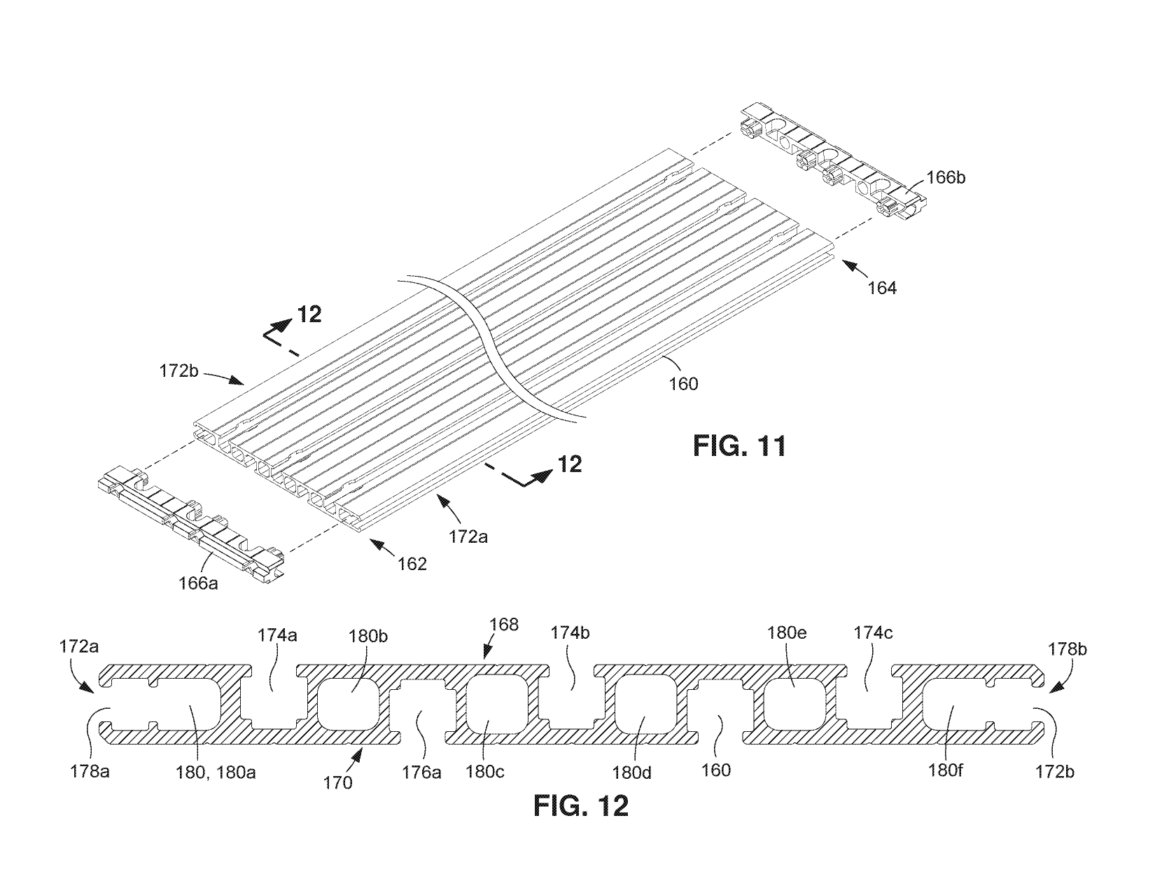

The endcaps 166 are understood to serve as the interface between the first axis crossmember 160 and the frame beam 54, as various embodiments contemplate the first axis crossmember 160 being coupled at the second elevation extension 74 and the overhang end 112 thereof, and specifically with the side opening channel 114. Before considering the structural features of the endcap 166, however, additional features of the first axis crossmember 160 will be considered, as the endcap 166 also interfaces therewith. The cross-sectional view of FIG. 12 illustrates the first axis crossmember 160 having a generally planar structure with a top face 168, an opposed bottom face 170, a first side 172a, and an opposed side 172b. The top face 168 defines three open upward-facing channels 174, including a first upward-facing channel 174a, a second upward-facing channel 174b, and a third upward-facing channel 174c. The bottom face 170 defines two open downward-facing channels 176, including a first downward-facing channel 176a and a second downward-facing channel 176b. The first side 172a defines a first side-facing channel 178a, and the second side 172b defines a second side-facing channel 178b. Each of the aforementioned channels 174, 176, and 178 are understood to be T-slot channels, where there is a channel core along with a pair of inwardly extending lips that narrows the opening to the channel core.

Because the channels 174, 176, and 178 are utilized for mounting hardware, the first axis crossmembers 160 utilize other structures for coupling with the endcaps 166. Specifically, the first axis crossmember 160 define multiple endcap retention channels 180, including a first endcap retention channel 180a between the first side-facing channel 178a and the first upward-facing channel 174a, a second endcap retention channel 180b between the first upward-facing channel 174a and the first downward-facing channel 176a, a third endcap retention channel 180c between the first downward-facing channel 176a and the second upward-facing channel 174b, a fourth endcap retention channel 180d between the second upward-facing channel 174b and the second downward-facing channel 176d, a fifth endcap retention channel 180e between the second downward-facing channel 176d and the third upward-facing channel 174c, and a sixth endcap retention channel 180f between the third upward-facing channel 174c and the second side-facing channel 178b.

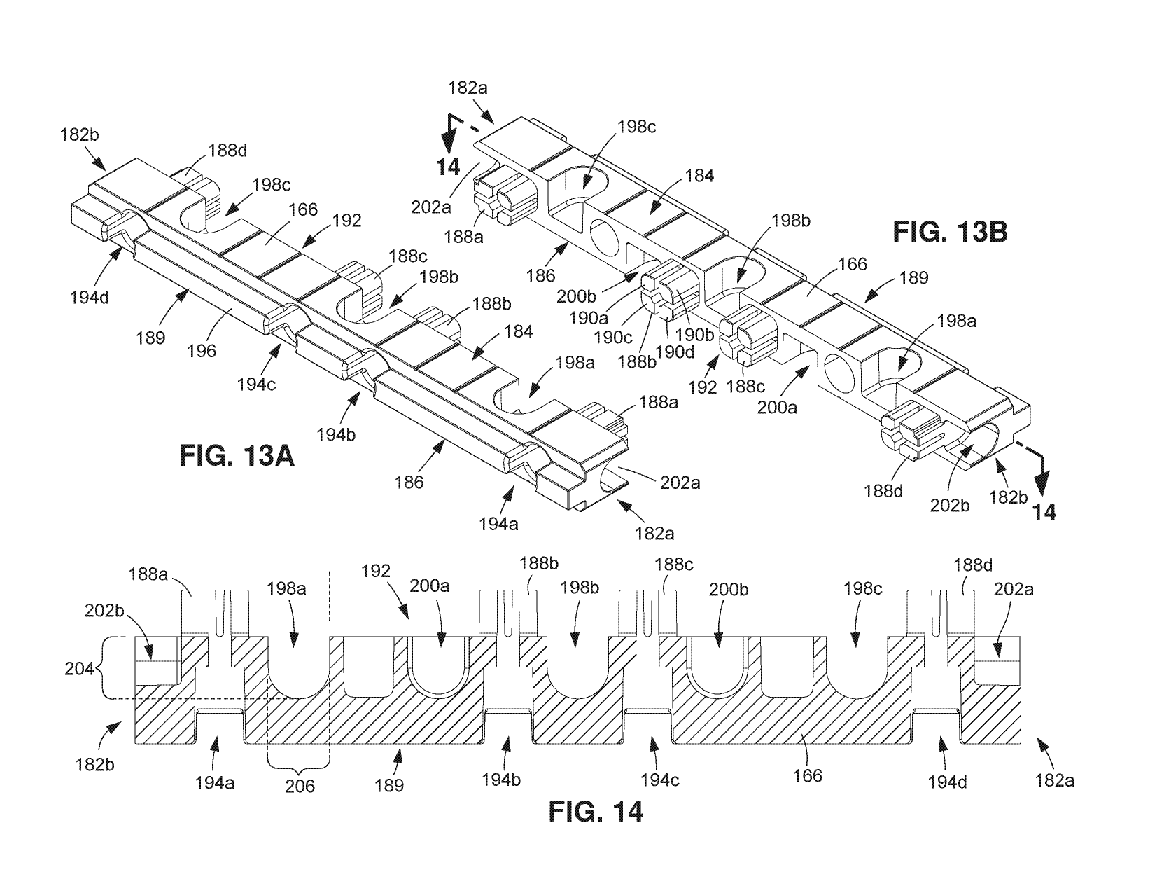

As will be detailed further, these endcap retention channels 180 receptively engage the endcap 166. With reference to FIGS. 13A, 13B, and 14, the endcap 166 has a flat elongate structure with first end 182a and an opposite second end 182b. Additionally, the endcap 166 is defined by a top face 184 and a bottom face 186, with a front end 189 that interfaces with the frame beam 54 and a rear end 192 that interfaces with the first axis crossmember 160. The thickness of the endcap 166 is substantially the same as the thickness of the first axis crossmember 160, with the top face 184 of the endcap 166 being substantially coplanar with the top face 168 of the first axis crossmember 160, and the bottom face 186 of the endcap 166 being substantially coplanar with the bottom face 170 of the first axis crossmember 160 when the endcap 166 is coupled thereto.

The rear end 192 includes one or more coupling tab structures 188 extending therefrom, including a first coupling tab structure 188a, a second coupling tab structure 188b, a third coupling tab structure 188c, and a fourth coupling tab structure 188d, each of which are spaced apart from each other. The coupling tab structures 188 may be comprised of four tab fingers 190 including an upper left tab finger 190a, an upper right tab finger 190b, a lower left tab finger 190c, and a lower right tab finger 190d. The tab fingers 190 are spaced apart from each other and define intersecting vertical and horizontal slots. A central passage 193 is defined at the intersection of these slots and extends from the rear end 192 to the front end 189. The front end 189, in turn, defines fastener openings 194 axially aligned with the central passages 193, including a first fastener opening 194a, a second fastener opening 194b, a third fastener opening 194c, and a fourth fastener opening 194d.

The coupling tab structures 188 are inserted into the endcap retention channels 180 of the first axis crossmember 160. The first coupling tab structure 188a is fitted inside the first endcap retention channel 180a, the second coupling tab structure 188b is fitted inside the third endcap retention channel 180c, the third coupling tab structure 188c is fitted inside the fourth endcap retention channel 180d, and the fourth coupling tab structure 188d is fitted inside the sixth endcap retention channel 180f. In this example, the second endcap retention channel 180b and the fifth endcap retention channel 180e are unused, as there are no corresponding coupling tab structures 188 extending from the rear end 192 of the endcap 166. However, this is by way of example only, and alternative embodiments may incorporate such additional coupling tab structures 188 that would be inserted into the second and fifth endcap retention channels 180b, 180e.

As indicated above, the coupling tab structures 188 are in a frictional engagement with the endcap retention channels 180. The retention may be further increased by the insertion of a fastener, preferably a threaded one such as a screw, through the fastener openings 194 and into the central passages 193. This is understood to spread the tab fingers 190 outwardly, increasing the cross-sectional profile of the coupling tab structure 188 against the walls of the endcap retention channels 180. The front end 162 of the endcap 166 may be defined by a rib 196 that spans its body. The rib 196 is sized and configured to fit within the side opening channel 114 of the frame beam 54.

The channels 174, 176, and 178 of the first axis crossmembers 160 are utilized for mounting hardware, and access thereto is provided through facial openings defined on the top face 168, bottom face 170, and the sides 172 of the endcap 166. Defined in the endcap 166 with openings on the top face 184 are top access slots 198a, 198b, and 198c, which may be aligned with the upward-facing channels 174a, 174b, and 174c, respectively, of the first axis crossmember 160. Similarly, defined in the endcap 166 with openings on the bottom face 186 are bottom access slots 200a and 200b, which may be aligned with the downward-facing channels 176a and 176b, respectively, of the first axis crossmember 160. The first end 182a of the endcap 166 defines a first side access slot 202a that is aligned with the first side-facing channel 178a, and the second end 182b defines a second side access slot 202b aligned with the second side-facing channel 178b.

Each of the access slots 198, 200, and 202 have a width greater than the narrowed openings of the channels 174, 176, and 178, and further have a short straight portion 204 and a half-moon portion 206. The access slots 198, 200, and 202 allow for the insertion of T-slot hardware, which in the illustrated embodiment, may be the M6 size.

Referring back to FIGS. 3 and 4, the roof rack frame assembly 18 further includes one or more second axis crossmembers 210 that span from the first axis frame beams 54a, e.g., between the passenger-side first axis frame beam 54a-1 and the driver-side first axis frame beam 54a-2. In the illustrated example, there are five second axis crossmembers 210a-210e, though the specific number, positioning, and distribution are presented by way of example only.

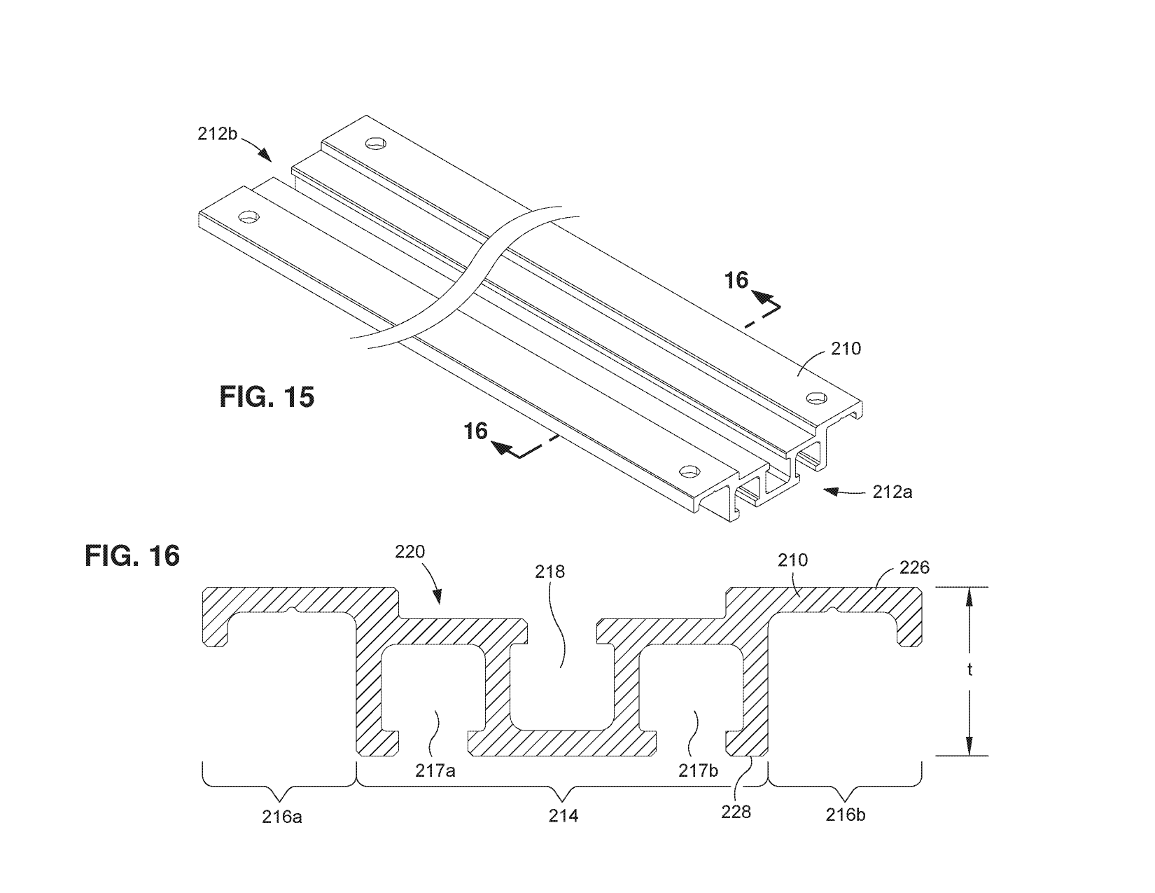

FIGS. 15 and 16 illustrate one embodiment of the second axis crossmember 210, which has an elongate structure with a first end 212a and an opposed second end 212b. The second axis crossmember 210 is defined by a primary beam 214 and a pair of outwardly extending wings 216a, 216b. The primary beam 214 further defines two downward channels 217a, 217b, as well as a single upward channel 218. Each of the channels 217a, 217b, and 218 are also understood to be T-slot channels with a core channel and a narrowed opening defined by inwardly extending lips. Thus, the channels can accept appropriate hardware to mount various accessories thereto. Furthermore, a recess 220 is defined between the wings 216 and the primary beam 214.

The second axis crossmember 210 is understood to be positioned in a vertically offset relationship, e.g., under the first axis crossmember 160 when assembled as part of the roof rack frame assembly 18. Referring back to the cross-sectional view of the frame beam 54, the second axis crossmember 210 is positioned within the space between the overhang bottom surface 110 and a bottom lip extension 111. In further detail, the bottom lip extension 111 defines a top surface 113 opposite the bottom surface 78 of the frame beam 54, with a crossmember retention slot 115 being defined between such surfaces. The thickness t of the second axis crossmember 210, that is, between its top surface 226 and its bottom surface 228, is substantially the same as the height dimensions of the crossmember retention slot 115.

The particulars shown herein are by way of example and for purposes of illustrative discussion of the embodiments of a vehicle roof rack and are presented in the cause of providing what is believed to be the most useful and readily understood description of the principles and conceptual aspects. In this regard, no attempt is made to show details with more particularity than is necessary, the description taken with the drawings making apparent to those skilled in the art how the several forms of the present disclosure may be embodied in practice.

What is claimed is:

1. A vehicle roof rack, comprising:
rack frame including a pair of first axis frame beams spaced apart from each other, a pair of second axis frame beams spaced apart from each other in a perpendicular relationship to the first axis frame beams, and frame couplings linking respective ones of the first axis frame beams to respective ones of the second axis frame beams; and
first and second side panels attachable to a vehicle roof, each of the side panels including one or more beam platforms to which the rack frame is mounted.

2. The vehicle roof rack of claim 1, wherein the side panels are each defined by a top edge facing the rack frame and a bottom edge defining a panel contour conforming to a contour of the vehicle roof.

3. The vehicle roof rack of claim 1, further comprising:
one or more foot brackets fixed to the side panels and attachable to mount points on the vehicle roof.

4. The vehicle roof rack of claim 1, further comprising:
one or more first axis crossmembers extending along the first axis frame beams and linkable with the second axis frame beams.

5. The vehicle roof rack of claim 4, further comprising:
one or more second axis crossmembers extending along the second axis frame beams and linkable with the first axis frame beams, the second axis crossmembers being vertically offset from the first axis crossmembers.

6. The vehicle roof rack of claim 5, wherein:
the first axis frame beam defines an open slot with a bottom lip receptive to the second axis crossmembers; and
the second axis cross members are defined by at least one upper channel with a top face opening and one or more lower channels each with a bottom face opening.

7. The vehicle roof rack of claim 4, wherein each of the first axis crossmembers are defined by one or more upward-facing channels with a top opening, one or more downward-facing channels each with a bottom opening, and side channels with side openings.

8. The vehicle roof rack of claim 7, further comprising:
endcaps attached to each end of the first axis crossmembers, the endcaps defining top face slots coinciding with respective ones of the one or more upper channels of the first axis crossmembers, bottom face slots coinciding with respective ones of the one or more lower channels of the first axis crossmembers, and side slots coinciding with respective ones of the side channels of the first axis crossmembers.

9. The vehicle roof rack of claim 7, wherein each of the upper channels, lower channels, and side channels are T-slots defined by a channel core and a pair of inwardly extending lips.

10. The vehicle roof rack of claim 1, further comprising:
a scene lighting luminaire mounted to one of the side panels.

11. The vehicle roof rack of claim 1, further comprising:
one or more luminaires collectively defining a light bar with a first end mounted to a first one of the side panels and an opposed second end mounted to a second one of the side panels.

12. A vehicle roof rack frame structure, comprising:
at least one first axis frame beam defining an upper channel, a lower channel, and one or more outer side channels;
at least one second axis frame beam defining an upper channel, a lower channel, and one or more outer side channels; and
a frame coupling including a first axis plug receptively engageable in the lower channel of the first axis beam frame and a second axis plug receptively engageable in the lower channel of the second axis beam frame and extending normally to the first axis plug, the frame coupling defining a first axis top slot aligned with the upper channel of the first axis frame beam, one or more first axis side slots aligned with a respective one of the one or more outer side channels of the first axis frame beam, a second axis top slot aligned with the upper channel of the second axis frame beam, and one or more second axis side slots aligned with a respective one of the one or more outer side channels of the second axis frame beam.

13. The vehicle roof rack frame structure of claim 12, wherein the frame beams are each defined by a first elevation base and a second elevation overhang extending from the first elevation base.

14. The vehicle roof rack frame structure of claim 13, wherein the frame coupling defines a first axis alignment slot and a second axis alignment slot, the locating slots being receptive to respective ones of the second elevation overhangs.

15. The vehicle roof rack frame structure of claim 12, wherein:
the first axis top slot of the frame coupling has a wider dimension than an opening to the upper channel of the first axis frame beam;
the first axis side slots of the frame coupling each have a wider dimension than the corresponding openings of the outer side channels of the first axis frame beam;
the second axis top slot of the frame coupling has a wider dimension than an opening to the upper channel of the second axis frame beam; and
the second axis side slots of the frame coupling each have a wider dimension than the corresponding openings of the outer side channels of the second axis frame beam.

16. A vehicle roof rack frame coupling, comprising:
a coupling body defined by a first end face and a second end face perpendicular to the first end face, a top face, and a first axis end face and a second axis end face perpendicular to the first axis end face;
a first axis plug and a second axis plug extending from a respective one of the first and second end faces of the coupling body; and
a first axis alignment slot and a second axis alignment slot on the respective one of the first and second end faces of the coupling body, each of the alignment slots being defined by at least a horizontal bottom wall and a vertical side wall;
wherein the first axis end face and the second axis end face each define one or more side access slots, and the top face defines at least one top access slot.

17. The vehicle roof rack frame coupling of claim 16, further comprising a coupling cover fitted onto the coupling body, the coupling cover including one or more electrical connectors accessible from each side of the coupling cover.

18. The vehicle roof rack frame coupling of claim 16, wherein the side access slots and the top access slot each have a generally semicircular end profile.

19. The vehicle roof rack frame coupling of claim 16, wherein the coupling body has a hollow interior, with each of the first and second end faces define an opening into the hollow interior.

20. The vehicle roof rack frame coupling of claim 16, wherein the first end face and the second end face each include one or more locating tabs extending therefrom.
